(19) United States
(12) Patent Application Publication
(10) Pub. No.: US 2019/0370504 A1
(43) Pub. Date: Dec. 5, 2019

(54) DIGITAL VALUE TOKENS CREATED AND SECURELY TRANSFERRED BY PROOF OF ELECTRICAL POWER GENERATION

(71) Applicant: Leo Edwardsson, Peoria, IL (US)

(72) Inventor: Leo Edwardsson, Peoria, IL (US)

(21) Appl. No.: 15/993,571

(22) Filed: May 30, 2018

(51) Int. Cl. G06F 21/86; H04L 9/32; G06Q 40/04; G06Q 50/06

(52) U.S. Cl. CPC G06F 21/86; H04L 9/3278; H04L 2209/38; G06Q 50/06; G06Q 40/04

(57) ABSTRACT

A system and method for operating a peer-to-peer blockchain network, for the purpose of creating and transferring digital electronic value tokens on a distributed, shared ledger. The invention uses Physical Unclonable Function (PUF) technology to create value tokens and prevent double spending of tokens, by enabling peers on the network to verify each others' uncounterfeitable identities. The peer devices are photovoltaic solar panels containing embedded PUF technology. The number of new value tokens they are entitled to create is determined by the amount of solar electric power they produce, and double spending is prevented by a consensus mechanism using the trust between peers enabled by PUF technology.

### CLAIM OF PRIORITY

This application claims the benefit and priority of U.S. Provisional Application No. 62/603,400 entitled “DIGITAL VALUE TOKENS CREATED AND SECURELY TRANSFERRED BY PROOF OF ELECTRICAL POWER GENERATION” filed May 30, 2017, which is hereby incorporated by reference in its entirety.

### FIELD OF THE INVENTION

This invention relates to a method and system for the creation and secure transfer of digital electronic value tokens. More particularly, the invention relates to a novel technique for creating digital value tokens, transferring digital value tokens, and recording digital value token transactions in a peer-to-peer blockchain network. Specifically, the invention relates to using Proof of Electrical Power Generation (henceforth abbreviated PoEPG) by peer members of the blockchain network, in order to create new digital value tokens and award it to the peers that generated the electricity, and to execute and record secure, reliable, non-reversible digital value token transfers between peers on the PoEPG blockchain network.

### BACKGROUND

Digital electronic value tokens based on peer-to-peer blockchain systems have become a fast growing field at the intersection of information technology, industry, and commerce. Starting with the creation of Bitcoin, the number of these digital value token systems has steadily increased, with technical variations designed to solve problems such as price inflation and digital value token devaluation, or exchange rate speculation and digital value token hoarding.

In order to create and assign new digital value tokens, and prevent double-spending of value tokens, most blockchain-based digital value token systems require peer computers in the blockchain network to solve difficult cryptographic problems, and broadcast their solutions in the form of mathematical hashes to the rest of the peer-to-peer network. This system is called Proof of Work (henceforth abbreviated PoW). The peer computers that perform this work are called miners.

PoW is intrinsically wasteful of resources. By design, it forces miners on the blockchain network to use computing power, and thus electricity, to find hashes that have no utility beyond the peer-to-peer digital value token network itself.

It is an object of the present invention to introduce an intrinsically resource efficient method of creating new digital value tokens and securing digital value token transfers on the blockchain network. It is a further object of this invention to promote the deployment of clean, distributed electrical power generating facilities. By awarding newly created digital electronic value tokens to members of the PoEPG blockchain network based on the amount of clean electrical power they prove they have generated, the invention will provide an incentive to join the PoEPG peer-to-peer network as a clean power producing member. These and other objects of the invention will be apparent to those skilled in the art from the description that follows.

### SUMMARY OF THE INVENTION

The method and the system of this invention center around the innovative concept of attaching specialized embedded computing devices to electrical power generating equipment, including but not restricted to photovoltaic solar panels, and using these embedded computing devices to generate Proof of Electrical Power Generation Signatures (henceforth abbreviated Proof Signatures). The Proof Signatures thus generated are used in a PoEPG peer-to-peer blockchain network instead of the hashes used by PoW blockchains. Specifically, the specialized embedded computing devices of this invention include Physical Unclonable Function (henceforth abbreviated PUF) hardware. PUF hardware is uncounterfeitable. Embedded computing devices with PUF hardware cannot be impersonated by software programs emulating the PUF because such emulation is not technically feasible. Other members of the PoEPG peer-to-peer blockchain network can be certain that messages from a PUF-equipped solar power station registered in the network are trustworthy. The use of PUF hardware to verify Proof Signatures is a novel method of operating a blockchain.

The other functions of this invention's specialized PUF embedded computing devices are power output metering, timing, communication with the PoEPG blockchain network, and tamper resistance. These functions enable the Proof Signatures verified by the PUF hardware to be integrated into new data blocks in the PoEPG blockchain.

The specialized PUF embedded computing device is attached directly to the photovoltaic solar power module at the point where the electrical current bus wires from the solar cells connect to external electrical transmission wiring. In the embodiment of the PoEPG embedded computing device illustrated in FIG. 1, this point is on the upper surface of the solar power module. In other embodiments, this point could be a junction box, microinverter, smartmeter, or similar hardware on the underside of the photovoltaic module. Attaching the embedded computing device at the point where the electrical current bus wires from the solar cells connect to external electrical transmission wiring prevents electrical power from external sources being added to the photovoltaic module's own output, and thus fraudulently claimed as solar power output. Tampering with the embedded computing device either destroys it, or triggers tamper detection functions in the embedded computing device causing it to stop communicating in its normal way with the PoEPG blockchain network.

In the embodiment illustrated in FIG. 3, individual stand-alone PUF-equipped photovoltaic modules act as fully functional solar power stations on the PoEPG blockchain network. Another possible embodiment could consist of a larger system made of one master PUF-equipped photovoltaic module and multiple subsidiary PUF-equipped photovoltaic modules. In this embodiment the PUF embedded computing device on each subsidiary module would communicate directly with the PUF embedded computing device on the master module, and the master module would communicate on their behalf with the PoEPG blockchain network, so the whole multi-panel system would act on the PoEPG blockchain network as one PUF-equipped solar power station.

The PUF-equipped solar power stations add Proof Signatures, which include a timestamp, to new data blocks they create and add to the PoEPG blockchain. Other members of the PoEPG blockchain network confirm that these proof signatures are valid by recognizing the uncounterfeitable PUF embedded computing devices that add them to the new blocks. These Proof Signatures take the place of the hashes used by PoW-based blockchain networks. The timestamps included in the proof signatures enable peers on the PoEPG blockchain network to determine which block candidate block should be confirmed in cases where they receive conflicting blocks from multiple PUF-equipped solar power stations. The new candidate block with the earliest time stamp wins.

Because miners in PoW-based blockchain networks race to solve a puzzle, and therefore take a highly variable amount of time to generate a mathematical hash before adding that hash to a new block, forks in the blockchain caused by two or more miners adding conflicting new blocks at the same time are uncommon. Because PoEPG blockchain peers do not race to a puzzle solution this way, there is a significant chance in a PoEPG system that two or more PUF-equipped Solar Stations will simultaneously add conflicting new blocks to the blockchain. In one embodiment, PUF-equipped Solar Stations that successfully add a block to the blockchain start a wait timer to reduce the chance of such conflicts. They will cease trying to add a new block to the PoEPG blockchain until the timer expires. To break the tie in cases where conflicting new blocks simultaneously appear even with wait timers in operation, a subset of the PUF-equipped peers act as a judging panel, deciding which branch of the PoEPG blockchain is the main chain.

When operated in the manner described herein, the PUF-equipped solar power stations in the PoEPG blockchain network use Proof Signatures to create new blocks and value tokens at much lower energy cost than miners use to generate hashes for the same purposes in PoW-based blockchain networks. This avoids the deliberate waste of energy and environmental impact of PoW-based blockchain networks.

### BRIEF DESCRIPTION OF THE DRAWINGS

A clear understanding of the key features of the invention summarized above may be had by reference to the appended drawings, which illustrate the method and system of the invention, although it will be understood that the drawings depict a preferred embodiment of the invention and, therefore, is not to be considered as limiting its scope with regard to other embodiments which the invention is capable of contemplating. Accordingly:

FIG. 1 is an illustration of a specialized PUF embedded computing device attached directly to the photovoltaic solar power module at the point where the electrical current bus wires from the solar cells connect to external electrical transmission wiring.

FIG. 2 is an enlarged illustration of the specialized PUF embedded computing device, depicting the components of the specialized PUF embedded computing device and the manner of its connection to the photovoltaic solar power module.

FIG. 3 is an illustration of the method and system of this invention, showing a simplified peer-to-peer PoEPG blockchain network consisting of PUF-equipped solar power stations, the blocks most recently added to the PoEPG blockchain, and network participants using the PoEPG blockchain to perform value token transactions.

### DETAILED DESCRIPTION OF THE INVENTION

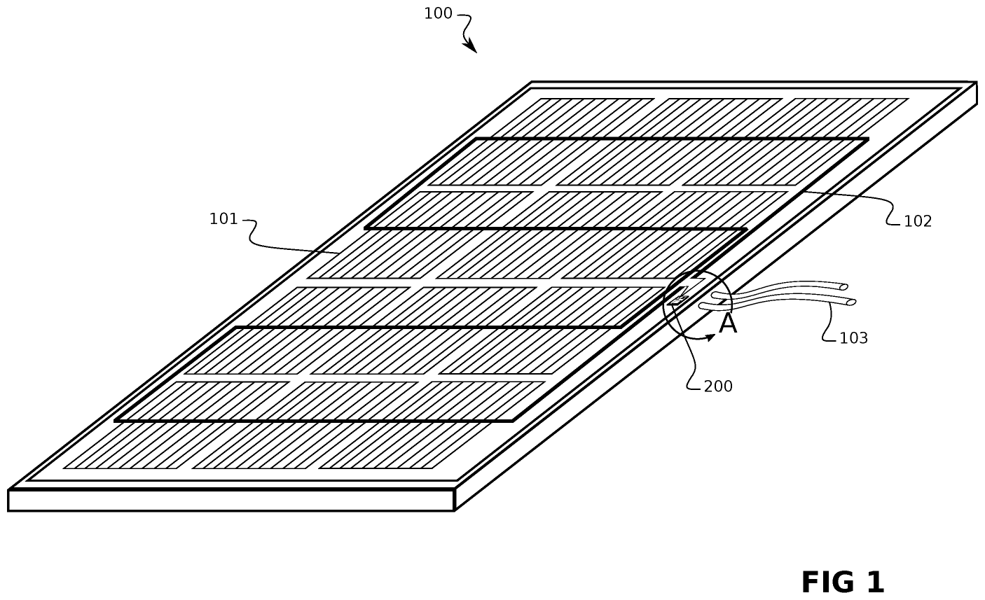

Referring to FIG. 1, a specialized PUF embedded computing device is attached directly as depicted in Detail A to photovoltaic solar power module 100. An array of photovoltaic cells 101 are connected by bus wires 102, which conduct the electric current generated by the cells to external transmission wires 103. Specialized PUF embedded computing device 200 continuously measures the electric current generated by solar power module 100, and uses those measurements as the basis for participation in the peer-to-peer PoEPG blockchain network.

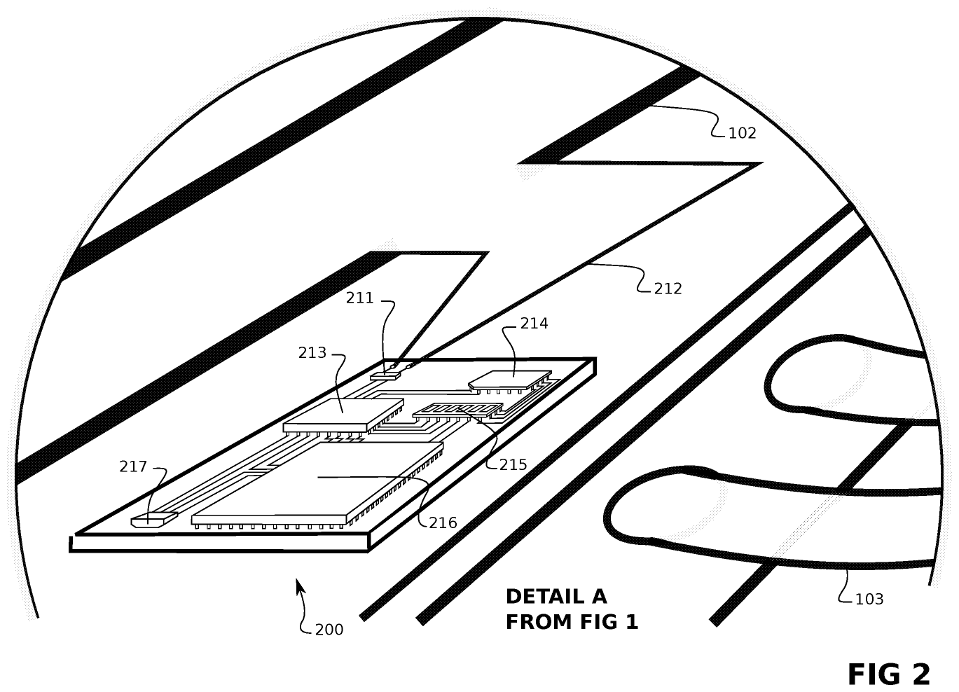

Referring to FIG. 2, specialized PUF embedded computing device 200 is depicted in an enlarged view of Detail A, attached directly to the top surface of the photovoltaic solar power module at the point where electrical current bus wires 102 connect to external electrical transmission wires 103. Specialized PUF embedded computing device 200 measures the electric current passing through bus wires 102 via current sensing shunt resistor 211 using a parallel circuit with connector wires 212.

In addition to current sensing shunt resistor 211, specialized PUF embedded computing device 200 is also comprised of processor 213, storage device 214, memory 215, network interface 216, and power supply interface 217. The components of specialized PUF embedded computing device 200 are depicted in this embodiment as individual parts interconnected by various data buses, but other embodiments are also possible. In the preferred embodiment, most or all of the components of specialized PUF embedded computing device 200 are integrated into a single microprocessor chip.

Processor 213 can process instructions for execution within specialized PUF embedded computing device 200, including instructions stored in storage device 214 or memory 215, to perform all the operations required for participation in the PoEPG peer-to-peer network.

Storage device 214 provides mass data storage for specialized PUF embedded computing device 200, including but not limited to processing instruction code, electric current measurement date, and device configuration parameters. In this embodiment, storage device 214 is implemented as solid state flash memory. Other embodiments, including but not limited to optical media, are also possible.

Memory 215 stores data within specialized PUF embedded computing device 200, and in the preferred embodiment is the hardware component on which the PUF is implemented. This embodiment uses Static Random Access Memory (henceforth abbreviated SRAM). Other embodiments, including but not limited to NVRAM and DRAM, are also possible. The tamper-resistant integration of PUF hardware into the photovoltaic solar module by this method is the basis of PoEPG.

Network interface 216 enables specialized PUF embedded computing device 200 to communicate with a general purpose network infrastructure, so that it may participate in the PoEPG peer-to-peer blockchain network. In this embodiment, network interface 216 is a wireless Ethernet device. Other embodiments, including but not limited to Bluetooth, CDMA, GSM, LTE radio devices, wired Ethernet devices, wired analog modem devices, and USB devices, are also possible.

Power supply interface 217 provides operational power for specialized PUF embedded computing device 200. In this embodiment it is depicted as a Micro USB connector socket, but other embodiments are also possible.

Specialized PUF embedded computing device 200 continually measures the amount of electric power generated by photovoltaic solar power module 100. It calculates the number of new digital value tokens it is entitled to create based on the measured amount of electric power output, and generates transaction records for the PoEPG blockchain to create and claim said value tokens.

Specialized PUF embedded computing device 200 also creates a new proof signature, which includes a timestamp, then adds said proof signature, said new token creation claim transaction records, and other supported transactions from a pool of pending transactions to a new data block, then broadcasts the new block to other PUF-equipped photovoltaic solar power stations on the PoEPG peer-to-peer network to add the new block to the PoEPG blockchain. The other PUF-equipped photovoltaic solar power stations on the PoEPG peer-to-peer network recognize specialized PUF embedded computing device 200 by means of its uncounterfeitable unique identity. In the preferred embodiment, all specialized PUF embedded computing devices are enrolled in the PoEPG peer-to-peer network upon first startup after manufacturing, and assigned a PKI private-public key pair at enrollment. The public key of the new specialized PUF embedded computing device is immediately transmitted to all pre-existing PUF-equipped photovoltaic solar power stations on the PoEPG peer-to-peer network. PUF-equipped photovoltaic solar power stations verify each others' uncounterfeitable unique identities by means of public-private key challenge-response messages on the PoEPG peer-to-peer network. Other embodiments are also possible.

When peer PUF-equipped photovoltaic solar power stations on the PoEPG peer-to-peer network have inspected the candidate new block created by Specialized PUF embedded computing device 200, and verified by means of specialized PUF embedded computing device 200's uncounterfeitable identity that the new block is valid, they also broadcast the new block to the rest of the PoEPG peer-to-peer network. By this method, consensus between the peers is achieved and the new block is confirmed as part of the PoEPG blockchain.

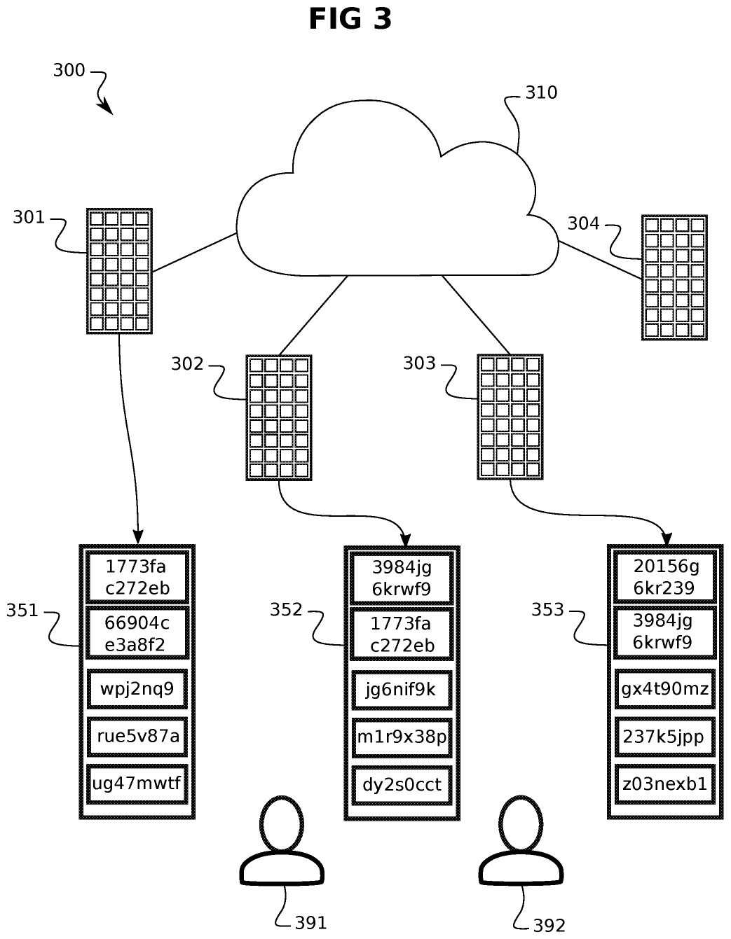

Referring to FIG. 3, four PUF-equipped photovoltaic solar power stations are shown communicating with each other in a PoEPG peer-to-peer network over general-purpose network infrastructure 310. In the embodiment illustrated in FIG. 3, the general purpose network infrastructure 310. is the public Internet. Embodiments using other network infrastructures are also possible.

Solar Station 301 has created Block 351 on the PoEPG blockchain, including new Proof Signature 1773fac272eb which is verified by the other PUF-equipped Solar Stations in the PoEPG blockchain network. Proof Signature 1773fac272eb will link Block 351 to subsequent blocks, maintaining the continuity and integrity of the PoEPG blockchain. Proof Signature 66904ce3a8f2 from an immediately previous block (not shown) is also included in Block 351, linking Block 351 to the previous block. Solar Station 301 also includes transactions in block 351. Transaction wpj2nq9 is Solar Station 301's own claim to create new value tokens based on Solar Station 301's electrical power output since its previous such claim. Verification of Proof Signature 1773fac272eb by the other PUF-equipped Solar Stations in the PoEPG peer-to-peer network is the mechanism by which Solar Station 301 proves the legitimacy of its claim to create new value tokens. Such value token claims are called Tokenbase Transactions. Solar Station 301 has also included transactions rue5v87a and ug47mwtf in Block 351. These may be any type of non-specific transaction supported by the PoEPG blockchain network.

Solar Station 302 has subsequently created Block 352 in a similar fashion. Solar Station 302 includes its own Proof Signature 3894jg6krwf9, the previous Proof Signature 1773fac272eb to link Block 351 to previous blocks in the chain, its own Tokenbase Transaction jg6nif9k, another non-specific example transaction m1r9x38p, and Value Token Transfer Transaction dy2s0cct. Transaction dy2s0cct records a transfer of digital electronic value tokens from Token Sender 391 to Token Recipient 392. The system by which Token Sender 391 and Token Recipient 392 interact with the PoEPG blockchain network is not shown. In one embodiment, Token Sender 391 may use a software program running on a smartphone to send value tokens to Recipient 392's PoEPG blockchain network address. Other embodiments, including but not limited to embodiments wherein the sender and recipient use mobile phone text messaging, hardware wallet devices, blockchain wallet software running on general purpose computers, third party online wallet services, or third party brokerage or exchange services are all possible.

Solar Station 303 has repeated the block creation process to create Block 353. New Block 353 contains Proof Signature 20156g6kr239 generated by Solar Station 303, previous Proof Signature 3894jg6krwf9 linking the new block to the chain, and example transaction records gx4t90mz, 237k5jpp, and z03nexb1. This process continues indefinitely, maintaining and extending the PoEPG blockchain.

In FIG. 3, the blocks are depicted with only three transactions records each, but in practice the blocks may contain many more transactions. In a preferred embodiment, the number of transactions per block, and therefore the block size in bytes of digital data storage, will be adjusted to optimize the performance of the PoEPG peer-to-peer blockchain network.

In FIG. 3, only individual PUF-equipped photovoltaic solar power stations actively producing electric current are shown directly creating and propagating new blocks on the PoEPG peer-to-peer blockchain network. In other embodiments, PUF-equipped photovoltaic modules can delegate some of their PoEPG blockchain building, maintenance, and propagation abilities to proxy systems, either temporarily or permanently. In an embodiment consisting of a larger system made of one master PUF-equipped photovoltaic module and multiple subsidiary PUF-equipped photovoltaic modules, only the master module acts as a solar power station directly building, maintaining, and propagating the PoEPG blockchain on the peer-to-peer network. The subsidiary modules delegate their PoEPG blockchain building, maintenance, and propagation abilities to the master module, using it as a proxy on the PoEPG blockchain network to include their claims to create new value tokens as tokenbase transactions in new blocks. In another embodiment, PUF-equipped photovoltaic modules can temporarily delegate a restricted subset of their PoEPG blockchain building, maintenance, and propagation abilities to a general purpose computing device acting as a proxy during sunless periods, when the PUF-equipped photovoltaic modules cannot generate electric power. The general purpose computing device acting as a proxy can create new blocks and add them to the PoEPG blockchain on behalf of the PUF-equipped photovoltaic module that delegated that ability to it, but it cannot claim new tokens by adding tokenbase transactions to its new blocks, because it does not generate solar electric power. The general purpose computing device acting as a proxy can facilitate prompt processing of value token transfer transactions and other supported transaction types on the PoEPG blockchain network using the subset of abilities delegated by the PUF-equipped photovoltaic module, until the PUF-equipped photovoltaic module receives enough sunlight to start generating electric power again and rejoin the PoEPG peer-to-peer blockchain network.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention. Accordingly, other embodiments are within the scope of the following claims.

What is claimed is:

1. A computing device-implemented method comprising: (a) measuring electrical power output of an electricity generating device, wherein said generating device is uniquely identified by a physical unclonable function, or “PUF”; (b) creating digital tokens that represent the electrical power so measured; (c) communicating with other computing devices of the same type in a peer-to-peer network, wherein devices check and validate the network membership of their peer devices using said physical unclonable functions; (d) rejecting communications from other computing devices that fail to authenticate themselves using said physical unclonable functions; (e) creating a ledger containing all digital tokens so generated, in the form of one or more data block chains; (f) continuously distributing updated copies of said block chains to every member device in said peer-to-peer network; (g) recording transactions in new data blocks, wherein said digital tokens are assigned to original owners or transferred between owners; (h) validating said transactions and new data blocks by means of a set of consensus rules using said physical unclonable functions; (i) appending said new data blocks to said block chains.

2. The computing device-implemented method in claim 1, wherein the electricity generating device is a photovoltaic system.

3. The computing device-implemented method in claim 1, wherein the computing device is directly attached in a tamper-resistant fashion to the photovoltaic system.

4. The computing device-implemented method in claim 1, wherein the value of the digital tokens corresponds to the amount of electrical power generated by the photovoltaic system.

5. The computing device-implemented method in claim 1, wherein double spending of the digital tokens is prevented by the consensus rules using physical unclonable functions.

6. A system comprising: A computing device comprising: a memory configured to store instructions; a processor to execute the instructions; an electrical energy measurement circuit; and one or more network interfaces to perform operations comprising: (a) measuring electrical power output of an electricity generating device, wherein said generating device is uniquely identified by a physical unclonable function, or “PUF”; (b) creating digital tokens that represent the electrical power so measured; (c) communicating with other computing devices of the same type in a peer-to-peer network, wherein devices check and validate the network membership of their peer devices using said physical unclonable functions; (d) rejecting communications from other computing devices that fail to authenticate themselves using said physical unclonable functions; (e) creating a ledger containing all digital tokens so generated, in the form of one or more data block chains; (f) continuously distributing updated copies of said block chains to every member device in said peer-to-peer network; (g) recording transactions in new data blocks, wherein said digital tokens are assigned to original owners or transferred between owners; (h) validating said transactions and new data blocks by means of a set of consensus rules using said physical unclonable functions; (i) appending said new data blocks to said block chains.

7. The system of claim 6, wherein the electricity generating device is a photovoltaic system.

8. The system of claim 6, wherein the computing device is directly attached in a tamper-resistant fashion to the photovoltaic system.

9. The system of claim 6, wherein the value of the digital tokens corresponds to the amount of electrical power generated by the photovoltaic system.

10. The system of claim 6, wherein double spending of the digital tokens is prevented by the consensus rules using physical unclonable functions.

11. One or more computer readable media storing instructions that are executable by a processing device, and upon such execution cause the processing device to perform operations comprising: (a) measuring electrical power output of an electricity generating device, wherein said generating device is uniquely identified by a physical unclonable function, or “PUF”; (b) creating digital tokens that represent the electrical power so measured; (c) communicating with other computing devices of the same type in a peer-to-peer network, wherein devices check and validate the network membership of their peer devices using said physical unclonable functions; (d) rejecting communications from other computing devices that fail to authenticate themselves using said physical unclonable functions; (e) creating a ledger containing all digital tokens so generated, in the form of one or more data block chains; (f) continuously distributing updated copies of said block chains to every member device in said peer-to-peer network; (g) recording transactions in new data blocks, wherein said digital tokens are assigned to original owners or transferred between owners; (h) validating said transactions and new data blocks by means of a set of consensus rules using said physical unclonable functions; (i) appending said new data blocks to said block chains.

12. The computer readable media of claim 11, wherein the electricity generating device is a photovoltaic system.

13. The computer readable media of claim 11, wherein the computer readable media is directly attached in a tamper-resistant fashion to the photovoltaic system.

14. The computer readable media of claim 11, wherein the value of the digital tokens corresponds to the amount of electrical power generated by the photovoltaic system.

15. The computer readable media of claim 11, wherein double spending of the digital tokens is prevented by the consensus rules using physical unclonable functions.
